(19) United States
(12) Patent Application Publication
(10) Pub. No.: US 2005/0236733 A1
(43) Pub. Date: Oct. 27, 2005

(54) Method and apparatus for producing mounting member of rotary cleaning member

(75) Inventors: Noriaki Chida, Kanagawa (JP); Hideki Mita, Kanagawa (JP)

Correspondence Address: FRISHAUF, HOLTZ, GOODMAN & CHICK, PC, 220 5TH AVE FL 16, NEW YORK, NY, 10001-7708, US

(73) Assignee: Toshiba Tec Kabushiki Kaisha, Tokyo (JP)

(21) Appl. No.: 11/117,970

(22) Filed: Apr. 29, 2005

Related U.S. Application Data
(63) Continuation of application No. PCT/JP03/04685, filed on Apr. 14, 2003.

(30) Foreign Application Priority Data
Oct. 31, 2002 (JP) 2002-318687
Jan. 16, 2003 (JP) 2003-008828

(51) Int. Cl. B29C 47/00

(52) U.S. Cl. 264/210.2; 425/382.3

(57) ABSTRACT

An aluminum material undergoes twisting while being extruded from an extrusion nozzle (53) of a molding device (51) so as to be formed into an extruded body (19) having a plurality of catching grooves (14) formed in a spiral along the cylindrical outer surface of the extruded body (19). The extruded portion of the extruded body (19) is further twisted by a twisting device (54). A shaft (15) having a plurality of catching grooves (14) formed in a spiral along the cylindrical outer surface thereof is formed by cutting the extruded body (19) to a given length. Dividing the process of twisting the shaft (15) ensures a sufficient twisting precision. As the shaft (15) can be twisted without being distorted, its roundness is improved. Vibration or noise due to irregular rotation of the rotary brush (13) is prevented. The floor brush (9) is made easier and more comfortable to use.

### CROSS-REFERENCE TO RELATED APPLICATION

This application is a continuation of International Application PCT/JP2003/004685 filed Apr. 14, 2003.

### TECHNICAL FIELD

The present invention relates to a method and an apparatus for producing a slender, cylindrical mounting member of a rotary cleaning member. The mounting member has one or more receiving grooves formed in a spiral along the cylindrical outer surface of the mounting member.

### BACKGROUND ART

One of conventionally known examples of methods of producing a shaft that serves as a mounting member of the type described above is disclosed in Japanese Laid-open Patent Publication No. 4-259429. The shaft described in Japanese Laid-open Patent Publication No. 4-259429 is generally in the shape of a solid, slender cylinder and used as a shaft portion of a rotary brush, which is disposed in a suction opening of a suction port body and rotatably supported by this shaft. The suction port body is adapted to connected to a vacuum cleaner. A plurality of receiving grooves having a twisted, spiral shape are formed along the cylindrical outer surface of the shaft. The receiving grooves are spaced apart and extend parallel to one another. The base end of a brush member having brush bristles embedded therein, a blade, or the like is snugly fitted in each receiving groove so as to extend along the length of receiving groove.

These blades or brush members are attached to the cylindrical outer surface of the shaft in such a manner as to be wound around the shaft in a spiral and radially project from the cylindrical outer surface of the shaft. With the configuration as above, rotation of the shaft causes the blades and the brush members to scrape up or collect dirt off a surface to be cleaned. The shaft is formed of aluminum by cutting to a desired length an extruded body which is formed by extruding an aluminum material in the shape of a solid, slender cylinder from an extrusion nozzle while circumferentially twisting this aluminum material.

Another example of methods of producing such a shaft is disclosed in Japanese Laid-open Patent Publication No. 7-178016. The shaft production method disclosed in Japanese Laid-open Patent Publication No. 7-178016 calls for forming an extruded body by extruding an aluminum material so that straight receiving grooves are formed on the extruded body, and circumferentially twisting the extruded body that has been extruded from the extrusion nozzle, thereby forming the extruded body into a shaft having a plurality of receiving grooves formed in a spiral along its cylindrical outer surface.

As described above, according to the shaft production method that calls for forming an extruded body by simultaneously twisting and extruding an aluminum material from an extrusion nozzle, the extruded body is formed merely by twisting the aluminum material simultaneously with its extrusion. It is therefore difficult to twist the aluminum material evenly. In other words, it is difficult to twist the aluminum material with a satisfactory twisting precision.

The method that calls for producing a shaft by forming an extruded body having straight receiving grooves by extrusion of an aluminum material from an extrusion nozzle, and, thereafter, twisting this extruded body by only a single twisting action calls for twisting the extruded body while supporting both ends of the extruded body. As it is not easy to twist the extruded body evenly according to such a method, it is difficult to ensure the twisting precision of the extruded body.

When producing shafts, it is a common practice to extrude an aluminum material to a length of several tens of meters. However, each one of the methods described above presents a problem in that increasing the extrusion distance of the aluminum material increases the weight of the extruded aluminum material itself and consequently reduces the twisting force of the extrusion nozzle, resulting in an insufficient twisting precision.

In order to solve the above problems, an object of the invention is to provide a method and an apparatus for producing a mounting member of a rotary cleaning member which facilitates a satisfactory twisting precision.

### DISCLOSURE OF THE INVENTION

A method of producing a mounting member of a rotary cleaning member (hereinafter simply referred to as a mounting member) calls for forming a mounting member by simultaneously performing extrusion and circumferential twisting of a material so as to form a plurality of receiving grooves in a spiral along the cylindrical outer surface of the mounting member, and further twisting the extruded portion of the mounting member in a circumferential direction. While a mounting member is formed by simultaneously performing extrusion and circumferential twisting, the extruded portion is further twisted circumferentially. As the process of twisting the mounting member is divided into a plurality of actions, there is no need of applying a great twisting force to the mounting member in a single action. Therefore, the method of the invention described above facilitates a satisfactory twisting precision of the mounting member.

A method of producing a mounting member according to another feature of the invention calls for forming a mounting member by simultaneously performing extrusion and circumferential twisting so as to form a plurality of receiving grooves in a spiral along the cylindrical outer surface of the mounting member, and pulling the extruded mounting member. By pulling the mounting member that has undergone twisting while being extruded, slacking of the extruded mounting member is prevented. As the mounting member can be twisted evenly without the possibility of distortion, the mounting member is ensured of having a satisfactory twisting precision by a simple method.

A method of producing a mounting member according to yet another feature of the invention calls for forming a mounting member having a plurality of straight receiving grooves along the cylindrical outer surface thereof by extrusion, and circumferentially twisting the extruded mounting member while pulling this mounting member. By simultaneously pulling and twisting the mounting member when the mounting member is extruded, slacking of the extruded mounting member which would otherwise occur during the twisting process is prevented. As the mounting member can be twisted evenly without the possibility of distortion, the method of the invention described above facilitates a satisfactory twisting precision of the mounting member.

A mounting member manufacturing apparatus according to the invention includes a forming means and a twisting means. The forming means serves to form a mounting member having a plurality of receiving portions formed in a spiral along the cylindrical outer surface of the mounting member by simultaneously performing extrusion and circumferential twisting of a material. The twisting means is designed to support an end of the mounting member extruded from the forming means and, in this state, twist the mounting member in the direction in which the forming means twists the material. While supporting and twisting the mounting member, the twisting means moves in the direction in which the mounting member is extruded from the forming means. The twisting means is designed such that there is a given relationship between the angle of circumferential twisting of the mounting member and the distance traveled by the twisting means in the direction in which the mounting member is extruded from the forming means. As a result of the configuration which calls for forming a mounting member by twisting-extrusion by the forming means and twisting the mounting member circumferentially at such an angle to have a given relationship with the travel distance, the mounting member extruded from the forming means can be twisted at both the base end and leading end at a precise twisting angle in accordance with the distance traveled by the twisting means. Therefore, the device according to the invention ensures a constant degree of twisting per unit length of distance traveled by the twisting means. In other words, precision of twisting the mounting member is improved.

### BRIEF DESCRIPTION OF THE DRAWINGS

FIG. 1 is a partially-cutaway schematic side view of an apparatus for producing a mounting member according to a first embodiment of the present invention; FIG. 2 is a schematic sectional view of a part of said mounting member manufacturing apparatus; and FIG. 3 is a bottom view of a suction port body that incorporates said mounting member.

FIG. 4 is a vertical sectional view of said suction port body, and FIG. 5 is a perspective of a vacuum cleaner that incorporates said suction port body.

FIG. 6 is a schematic illustration of a part of a mounting member manufacturing apparatus according to a second embodiment of the present invention; FIG. 7 is a schematic illustration of a part of a mounting member manufacturing apparatus according to a third embodiment of the present invention; and FIG. 8 is a schematic illustration of a part of a mounting member manufacturing apparatus according to a fourth embodiment of the present invention.

FIG. 9 is a partially-cutaway schematic side view of a mounting member manufacturing apparatus according to a fifth embodiment of the present invention; FIG. 10 a schematic sectional view of a part of said mounting member manufacturing apparatus; and FIG. 11 is a schematic side view of a mounting member manufacturing apparatus according to a sixth embodiment of the present invention.

FIG. 12 is a schematic illustration of a mounting member manufacturing apparatus according to a seventh embodiment of the present invention; FIG. 13 is a schematic top view of said mounting member manufacturing apparatus; FIG. 14 is a perspective of an extrusion nozzle of said mounting member manufacturing apparatus; and FIG. 15 is a top view of the extrusion nozzle of said mounting member manufacturing apparatus.

FIG. 16 is a partially-cutaway front view of a twisting means of said mounting member manufacturing apparatus, and FIG. 17 is a partially-cutaway side view of said twisting means of the mounting member manufacturing apparatus.

FIG. 18 is a partially-cutaway top view of said twisting means of the mounting member manufacturing apparatus, and FIG. 19 is a partially-cutaway top view of another example of the twisting means of the mounting member manufacturing apparatus.

### BEST MODE FOR CARRYING OUT THE INVENTION

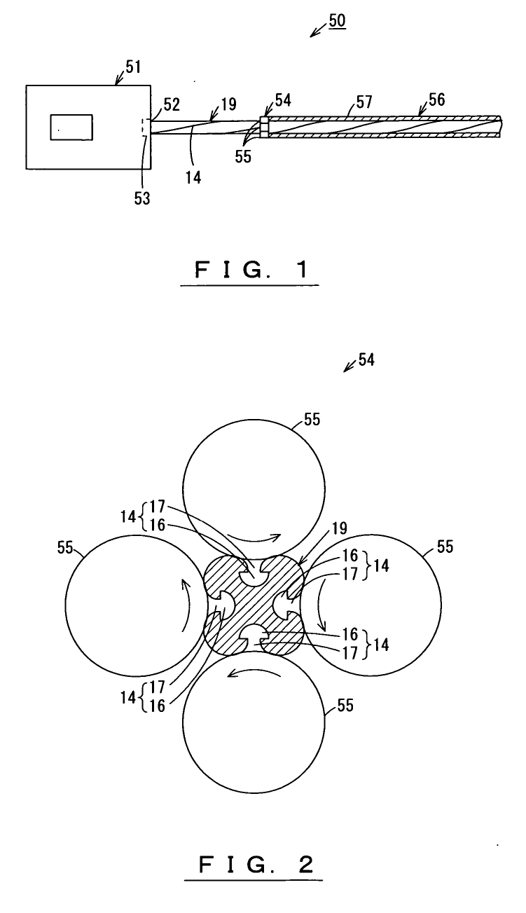

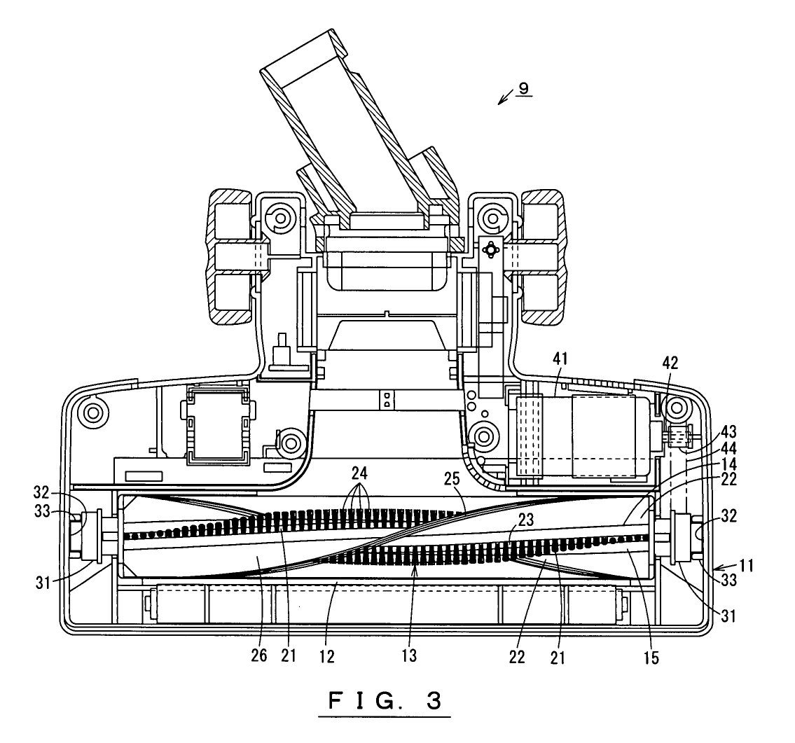

Next, the structure of a vacuum cleaner according to a first embodiment of the present invention is explained, referring to FIGS. 1 through 5.

Referring to FIGS. 3 through 5, numeral 1 denotes the main body of the cleaner. The cleaner main body 1 incorporates a motor fan 2. A cleaner main body suction port 3 is open at the approximate center of the front side of the cleaner main body 1. A floor brush 9 that serves as a suction port body is communicatively connected to the cleaner main body suction port 3 via a hose assembly 4 and an extension pipe 8.

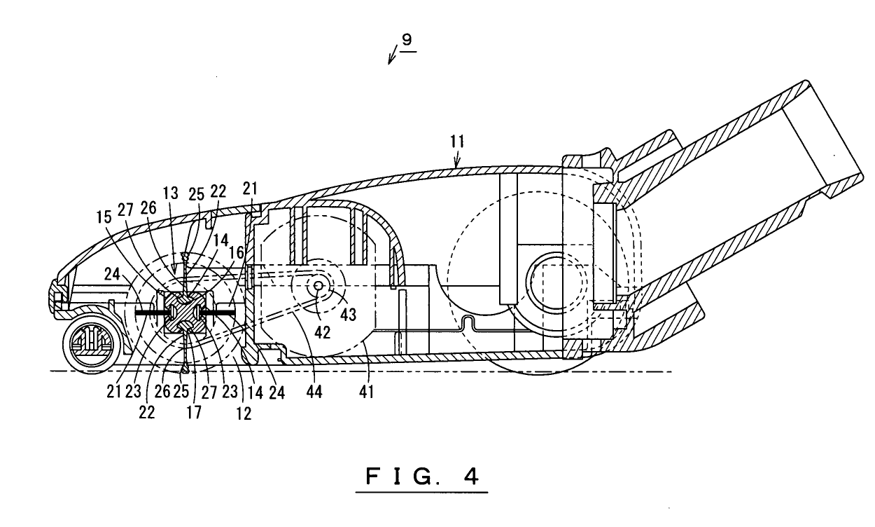

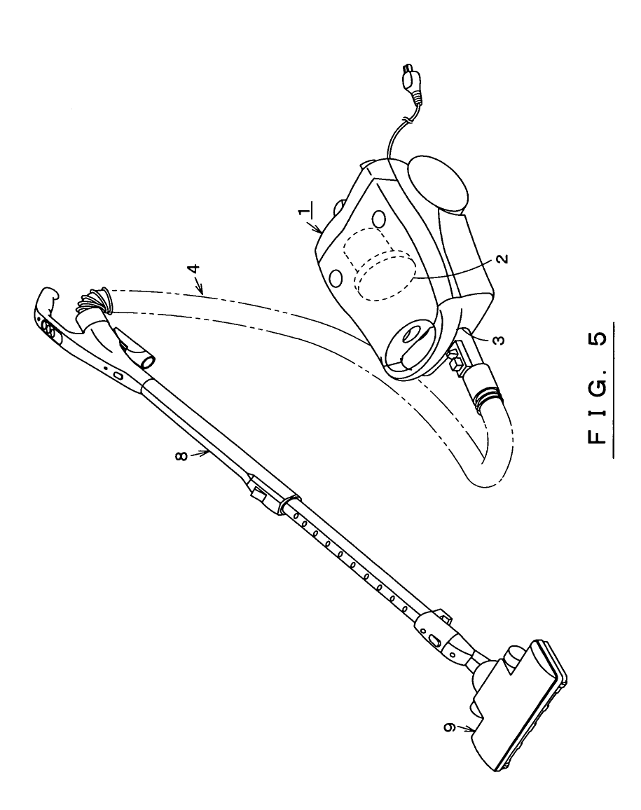

As shown in FIGS. 3 and 4, the floor brush 9 includes a hollow casing 11 and a narrow, rectangular suction opening 12 is formed at the bottom of the casing 11. A slender, substantially cylindrical rotary brush 13 which serves as a rotary cleaning member is disposed inside the suction opening 12. The rotary brush 13 is supported by a shaft so as to be capable of smoothly rotating in the traveling direction of the floor brush 9. The rotary brush 13 is provided with a shaft 15, which serves as a mounting member for supporting the rotary brush 13. As shown in FIG. 3, the shaft 15 is a grooved brush base having a substantially cylindrical slender shape provided with a plurality of catching grooves 14 formed in the cylindrical outer surface of the shaft 15. In the case of the present embodiment shown in FIG. 3, four catching grooves 14 are provided. The catching grooves 14 serve as receiving portions or receiving grooves referred to in claims or Disclosure of the Invention. Each catching groove 14 has a recessed cross section and extends in a spiral along the length of the shaft 15.

The shaft 15 is formed by evenly twisting a material circumferentially so that the catching grooves 14 formed in the cylindrical outer surface of the shaft 15 are curved in a spiral. The catching grooves 14 of the shaft 15 are circumferentially spaced apart at regular intervals. The shaft 15 is formed of a metal, such as aluminum, or any other appropriate material that can be extruded and twisted.

The shaft 15 is formed by extruding an aluminum material while twisting it so that the extruded portion is formed into an extruded molding 19, which serves as a blank, with a plurality of catching grooves 14 formed in a spiral along the cylindrical outer surface of the extruded molding 19, and, before the extruded molding 19 naturally cools down, circumferentially twisting the extruded molding 19 further while supporting the lower part of the extruded molding 19.

As shown in FIG. 4, each catching groove 14 is comprised of a flaring portion 16, which forms the inner portion of the catching groove 14 and has a wider cross section, and a communicating portion 17, which is narrower than the flaring portion 16 and links the flaring portion 16 with the outer surface of the shaft 15. In other words, the cross section of the shaft 15 is in the shape of a recess having a narrow opening, with its opening portion indented like a step. The flaring portion 16 of each catching groove 14 has a base end that is formed in an inwardly curved arc when viewed in a cross section, and an outer end whose inner edge is a flat surface that faces toward the base end.

Brush members 21 and scraping members 22 comprise cleaning members. The brush members 21 and the scraping members 22 are alternately arranged around the shaft 15, with their base ends secured in the catching grooves 14. The brush members 21 and the scraping members 21 are attached to the shaft 15 in such a manner that each one of the members extends in the axial direction of the shaft 15 and rises at a right angle like a wall from the cylindrical outer surface of the shaft 15.

Each brush member 21 includes a brush attaching portion 23 in the shape of a narrow, rectangular plate. Each brush attaching portion 23 is formed of soft vinyl chloride or the like in a shape having a cross section similar to that of each catching groove 14 of the shaft 15 so that the brush attaching portion 23 can be removably fitted in the catching groove 14. Bundles of bristles 24 are arranged along the length of each brush attaching portion 23 and embedded in its outer surface so that the bristles 24 project like a ridge from the brush attaching portion 23.

Each scraping member 22 includes an elastic blade 26 in the shape of a narrow, flat strip formed of soft vinyl chloride or the like. One of the two lengthwise edges of each blade 26 is formed into a scraper portion 25 by thickening both sides that flank said edge so that the scraper portion 25 has an undulating cross section. A blade attaching portion 27 having a shape of a narrow, flat strip is formed along the other lengthwise edge of each blade 26 as an integral body with the blade 26. Each blade attaching portion 27 is formed of the same material as the blade 26 into a similar shape to the brush attaching portion 23 of each brush member 21.

Thus, the brush members 21 and the scraping members 22 are attached to the shaft 15 with the brush attaching portions 23 of the brush members 21 and the blade attaching portions 27 of the scraping members 22 snugly fitted in the catching grooves 14 of the shaft 15. As shown in FIG. 3, substantially cylindrical receiving members 31 that serve as supporting members are coaxially attached to the two axial ends of the shaft 15.

A pair of shaft supporting recesses 32 are formed at both sides of the suction opening 12 in the casing 11 of the floor brush 9. “Both sides” of the suction opening 12 means the two lateral ends of the suction opening with respect to the traveling direction of the floor brush 9. A substantially cylindrical bearing member 33 is fitted in each shaft supporting recess 32. The bearing members 33 are rotatably fitted to the ends of the receiving members 31 respectively so that the axial ends of the shaft 15 are rotatably secured to the bearing members 33. Thus, the shaft 15 are rotatably supported between the two shaft supporting recesses 32 by the bearing members 33.

A motor 41 serving as a driving means is contained in the casing 11 of the floor brush 9, at a location behind the suction opening 12. The motor 41 is disposed to one side of the casing 11. A rotary shaft 42 protrudes from the distal end of the motor 41 and adapted to rotate as a result of rotation of the motor 41. A pulley 43 is concentrically attached to the rotary shaft 42. The pulley 43 is located behind one of the receiving members 31 of the rotary brush 13, which is installed in the suction opening 12 of the floor brush 9. The pulley 43 is adapted to rotate in the direction of rotation of the receiving member 31 located in front of the pulley 43.

An endless belt 44 is extended in a loop around the said one of the receiving members 31 of the rotary brush 13 and the pulley 43 of the rotary shaft 42 of the motor 41. Therefore, when rotation of the rotary shaft 42 of the motor 41 rotates the pulley 43, the belt 44 rotates the corresponding receiving member 31 of the rotary brush 13, thereby rotating the rotary brush 13.

Next, the configuration of an apparatus for producing a shaft that has a structure according to the first embodiment described above.

Referring to FIGS. 1 and 2, numeral 50 denotes a shaft manufacturing apparatus serving as a mounting member manufacturing apparatus. The shaft manufacturing apparatus 50 includes a molding device 51 in the shape of a substantially rectangular block. The molding device 51 is the main body of the shaft manufacturing apparatus 50 and serves as a forming means. The molding device 51 is a twist-and-extrude device, which is an aluminum extruder. The interior of the molding device 51 is filled with an aluminum material, which is not shown in the drawings. The aluminum material can be heated inside the molding device 51 and extruded therefrom. A cylindrical extrusion port 52 is formed at the center of one side of the molding device 51. The extrusion port 52 is open in the horizontal direction so that the axis of the cylindrical extrusion port 52 extends in parallel with a normal to the aforementioned side of the molding device 51. A substantially cylindrical extrusion nozzle 53 is concentrically attached to the extrusion port 52 so that the aluminum material filling the interior of the molding device 51 can be extruded from the extrusion nozzle 53.

The aluminum material filling the interior of the molding device 51 is extruded from the extrusion nozzle 53 in the direction perpendicular to the open surface of the extrusion nozzle 53 while being evenly twisted in a circumferential direction. As a result of this twisting-extrusion, an extruded body 19 is formed. The extruded body 19 thus extruded has a plurality of catching grooves 14 that extend in a spiral along the cylindrical outer surface of the extruded body 19, because protrusions that would form such spiral catching grooves 14 along the cylindrical outer surface of the extruded body 19 are formed in the inner surface of the extrusion nozzle 53. These protrusions of the extrusion nozzle 53 are not shown in the drawings.

A twisting device 54 that faces towards the opening of the extrusion nozzle 53 is disposed at a given distance therefrom. The twisting device 54 serves as a twisting means for further twisting an extruded body 19 that has been extruded from the extrusion nozzle 53 while being twisted. The twisting device 54 includes a plurality of rotatable rollers 55 having a flat, disk-like shape. In the case of the present embodiment, four rollers 55 are provided. The rollers 55 collectively serve as a twisting means and are adapted to bring a part of the outer surface thereof into contact with the cylindrical outer surface of an extruded body 19 that is extruded from the extrusion nozzle 53 by a given distance and further twist the portion of the extruded body 19 between the extrusion nozzle 53 and the rollers 55 in normal circumferential direction.

To be more specific, the rollers 55 are arranged around the extruded body 19 extruded from the extrusion nozzle 53. They are spaced apart from one another at regular intervals circumferentially around the extruded body 19, with a part of each roller 55 being in contact with the cylindrical outer surface of the extruded body 19. In an actual working example, the rollers 55 are arranged so that a part of the surface of the cylindrical edge of each roller 55 comes into contact with the cylindrical outer surface of an extruded body 19 immediately after it is pushed out of the extrusion nozzle 53. The extruded body 19 has to come into contact with the rollers 55 before it becomes naturally hard. The rollers 55 are arranged to come into contact with the extruded body 19 at four locations, respectively, i.e. the top, the bottom, and the two lateral ends as viewed from the front, in such a manner that the contact surfaces of the rollers are parallel with the cylindrical outer surface of the extruded body 19.

Of the four rollers 55, the one that is located on the right side as viewed from the front is adapted to be rotated by a driving means (not shown) at a variable rotation speed and direction. The direction and speed of rotation of the right-side roller 55 can be changed by a control means that controls said driving means. The other rollers 55, i.e. those located on the top, the bottom, and the left side as viewed from the front, are rotatably supported by respective shafts so that rotation of the right-side roller 55 twists the extruded body 19. The extruded body 19 consequently forces the remaining three rollers 55 to slide and rotate around the extruded body 19.

A guide device 56, which is a supporting device for preventing slackening, supports the lower part of the extruded body 19 that has thus been twisted further by the rollers 55 in order to prevent the extruded body 19 from slackening due to its own weight. The guide device 56 includes a slender, cylindrical tubular portion 57. The tubular portion 57 is a supporting cylinder which functions as a guide wall for an extruded body 19. An extruded body 19 that has been twisted further by the twisting device 54 is inserted into the tubular portion 57 and held therein.

The tubular portion 57 permits the extruded body 19 that has been gradually extruded from the extrusion nozzle 53 and twisted further by the twisting device 54 to be gradually inserted into the tubular portion 57 and supports the lower part of the extruded body 19 to prevent slackening, which would otherwise occur due to the weight of the extruded body 19 before the extruded body 19 becomes naturally hard. Another function of the tubular portion 57 is to guide the extruded body 19 by permitting the extruded body 19 to be inserted therein after the extruded body 19 has been twisted by the twisting device 54.

Next, a method of producing a floor brush according to the first embodiment described above is explained.

After filling the interior of the molding device 51 of the shaft manufacturing apparatus 50 with an aluminum material, the shaft manufacturing apparatus 50 is started up.

As a result of the activation of the shaft manufacturing apparatus 50, the aluminum material is heated and, when it is ready to be formed, undergoes twisting as it is pushed out of the extrusion nozzle 53 of the shaft manufacturing apparatus 50. Thus, an extruded body 19 is formed, with a plurality of catching grooves 14 formed in a spiral along the cylindrical outer surface of the extruded body 19.

The catching grooves 14 formed along the cylindrical outer surface of the extruded body 19 are in the shape of a spiral having a longer turning pitch than that of the catching grooves 14 of the shaft 15 into which the extruded body 19 is to be formed.

The extruded body 19, which is the portion of the material extruded from the extrusion nozzle 53 of the shaft manufacturing apparatus 50, is inserted into the space between the rollers 55 of the twisting device 54, which is so disposed as to directly face the extrusion nozzle 53, and rotated by these rollers 55 so that the extruded body 19 is further twisted circumferentially.

At that time, the extruded body 19 that has been extruded from the extrusion nozzle 53 of the shaft manufacturing apparatus 50 is twisted by the rollers 55 in such a state that the two ends of the extruded body 19 are secured by the extrusion nozzle 53 and the rollers 55 to prevent rotation.

After being twisted by the rollers 55, the turning pitch of the spirals of the catching grooves 14 that are formed along the cylindrical outer surface of the extruded body 19 is the same as that of the catching grooves 14 of the shaft 15 into which the extruded body 19 is to be formed.

After being twisted by the rollers 55, the extruded body 19 is inserted into the tubular portion 57 of the guide device 56 so that the inner surface of the tubular portion 57 supports the bottom of the extruded body 19 to prevent slackening, which would otherwise occur due to the weight of the extruded body 19 before the extruded body 19 becomes naturally hard.

By cutting the extruded body 19 to a given length after the extruded body 19 has naturally hardened, formation of the shaft 15 is completed.

Thereafter, the brush attaching portions 23 of the brush members 21 and the blade attaching portions 27 of the scraping members 22 are securely fitted in the catching grooves 14 of the shaft 15 so that the brush members 21 and the scraping members 22 extend along the length of the shaft 15 and are alternately arranged in the circumferential direction.

Next, the rotary brush 13 is assembled by fitting the receiving members 31 to both ends of the shaft 15 and rotatably fixing a bearing member 33 to the end of each receiving member 31.

Then, by respectively fitting the bearing members 33 of the rotary brush 13 to the shaft supporting recesses 32 of the casing 11 so as to rotatably secure the rotary brush 13 in the suction opening 12 of the casing 11 and wrapping the belt 44 around said one of the receiving members 31 of the rotary brush 13, assembly of the floor brush 9 is completed.

Next, how cleaning is performed by using the device according to the first embodiment described above is explained hereunder.

When cleaning is performed, the hose assembly 4 is held and pushed to move the floor brush 9 back and forth on the floor.

At that time, suction force generated by driving the motor fan 2 in the cleaner main body 1 causes dirt on the floor to be sucked into the suction opening 12 of the floor brush 9 together with the air.

If the rotary brush 13 of the floor brush 9 is rotated, rotation of the brush members 21 of the rotary brush 13 causes the bristles 24 of the brush members 21 to brush the floor.

In cases where the floor surface is of a wooden flooring or the like, dirt adhering to the floor surface is brushed up off the floor and sucked into the suction opening 12 of the floor brush 9.

Meanwhile, the scraping members 22 of the floor brush 13 rotates to wipe dirt off the floor surface. To be more specific, when the floor surface is of a carpet or the like, dirt embedded in the carped is scraped up by the scraper portions 25 of the blades 26 of the scraping members 22 and sucked into the suction opening 12 of the floor brush 9.

Thereafter, the dirt-laden air that has been sucked in from the suction opening 12 of the floor brush 9 is carried through the hose assembly 4 and the extension pipe 8 into the cleaner main body suction port 3 of the cleaner main body 1, in which the dirt is trapped and collected.

As described above, the first embodiment of the invention employs so-called two-stage twisting, which calls for, in the case of the first embodiment, forming an extruded body 19 that has catching grooves 14 formed in a spiral along its cylindrical outer surface by forming an aluminum material into a solid, slender cylindrical shape by extrusion through the extrusion nozzle 53 of the molding device 51 of the shaft manufacturing apparatus 50 while circumferentially twisting the material so as to form said catching grooves 14, and, thereafter, further twisting the extruded body 19 by means of rotation of the rollers 55.

This method is effective in distributing the twisting force to be applied to the extruded body 19 when the extruded body 19 having catching grooves 14 formed in a spiral along its cylindrical outer surface is formed by extrusion and twisting of a slender, cylindrical aluminum material. As the extruded body 19 is formed while being twisted with its force distributed, there is no need to apply a great twisting force to the extruded body 19 all at once. Therefore, a shaft 15 to be produced from the extruded body 19 is ensured of having a desired twisting precision by a simple method such as, for example, controlling the rotation torque of the rollers 55.

As the extruded body 19 which serves as the blank to produce the shaft 15 can be evenly twisted without being distorted, the method according to the first embodiment prevents ensures an improved roundness of the shaft 15 produced from the extruded body 19. When rotated, a rotary brush 13 equipped with a shaft 15 produced by this method is free from the problem of vibration or noise that would otherwise result from irregular rotation of the rotary brush 13. Therefore, a floor brush 9 equipped with a rotary brush 13 according to the embodiment is easier to use.

The embodiment described above calls for bringing the cylindrical surfaces of the rollers 55 into contact with the extruded body 19, which is extruded from the extrusion nozzle 53 of the molding device 51 while being twisted, at four locations respectively, i.e. the top, bottom, right and left sides of the cylindrical outer surface of the extruded body 19. Therefore, in the embodiment, twisting the extruded body 19 enables the extruded body 19 to be twisted evenly along its axial length without the need of changing the rotation speed of the rollers 55. In other words, a shaft manufacturing apparatus according to the embodiment ensures a uniform degree of twisting of the extruded body 19 along the entire axial length while having a simple structure.

As yet another feature the embodiment described above, the right-side roller 55 of the twisting device 54, which is a roller located on the right side as viewed from the front, is designed to be driven to rotate and thereby twist the extruded body 19, while the other rollers 55 of the twisting device 54, i.e. those located on top of, under, and left of the extruded body 19 as viewed from the front, are rotated as slave motion to the extruded body 19 being twisted by rotation of the right-side roller 55.

As a result of the feature described above, the extruded body 19 can be evenly twisted merely by rotating the roller 55 located to the right of the extruded body 19 as viewed from the front; there is no need of rotating all the rollers 55. A device having this feature is therefore ensured to give an appropriate twisting precision to a shaft 15 to be produced from the extruded body 19 by a simpler structure. It is easy for a device according to the embodiment to provide a shaft having a desired twist angle, because the device is capable of producing shafts 15 having different twist angles by changing the direction or speed of rotation of the roller 55 located to the right of the extruded body 19 as viewed from the front.

As the extruded body 19 twisted by the twisting device 54 is inserted into the tubular portion 57 of the guide device 56 so that the tubular portion 57 supports the lower part of the extruded body 19, slackening of the extruded body 19, which would otherwise occur due to the weight of the extruded body 19 before the extruded body 19 becomes naturally hard, can be prevented. As the twisted extruded body 19 is prevented from becoming distorted before it hardens, a shaft 15 to be produced from the extruded body 19 will have an improved roundness.

The first embodiment of the invention described above calls for further twisting an extruded body 19 that has undergone twisting while being extruded through the extrusion nozzle 53 of the molding device 51, and, thereafter, supporting the extruded body 19 by means of the guide device 56. However, there are other means to twist the extruded body 19 while preventing the extruded body 19 from slackening before it becomes hard by unaided cooling; for example, such an effect can be achieved by twisting the extruded body 19 extruded from the extrusion nozzle 53 of the molding device 51 while applying an axial tension to this extruded body 19 by pulling an end of the extruded body 19 in the axial direction. This alternate method is effective in evenly twisting the extruded body 19 and preventing its distortion, thereby ensuring the extruded body 19 has a superior roundness when twisting of the extruded body 19 is completed.

Although only one of the rollers 55 of the twisting device 54, i.e. the roller 55 to the right as viewed from the front, is driven to rotate according to the first embodiment described above, the same effect as that of the first embodiment can be achieved by rotating at least any one of the rollers 55; for example, all the rollers 55 may be driven to rotate.

Furthermore, according to the first embodiment described above, shafts 15 are produced by an extrusion process using the shaft manufacturing apparatus 50 so as to form an extruded body 19 having a length equivalent to a plurality of shafts 15 connected to one another, and cutting the extruded body 19 to a given length. However, the shaft manufacturing apparatus 50 may be used to form an extruded body 19 that has the same length as that of the shaft 15 to be produced as a final product.

Although the extruded body 19 that has been twisted by the rollers 55 of the twisting device 54 is allowed to cool and harden according to the first embodiment, the extruded body 19 may be forced to cool down by air-cooling, such as air blowing by a fan, water-cooling, such as spraying water, or any other appropriate method.

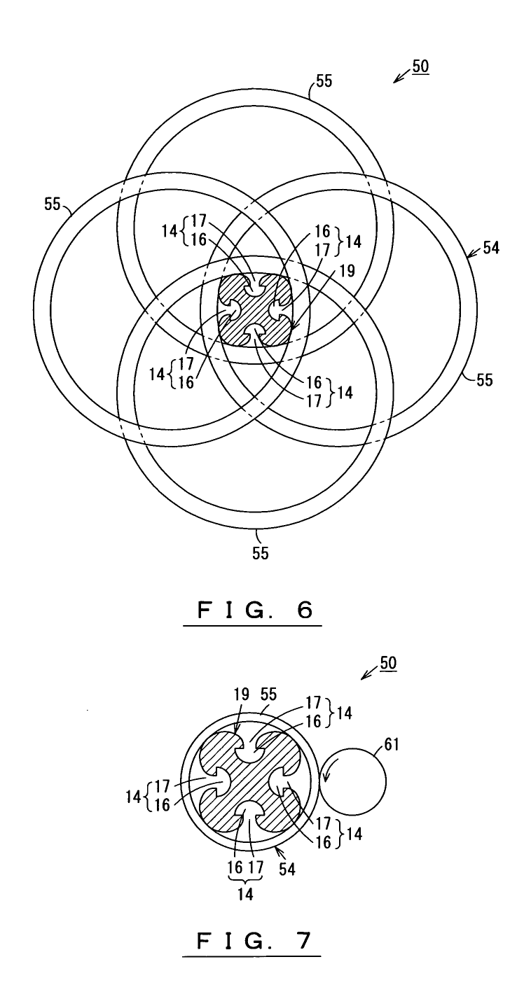

Furthermore, according to the first embodiment described above, each roller 55 of the twisting device 54 has a flat, disk-like shape, and designed so that a part of its cylindrical outer surface comes into contact with each one of the four locations, i.e. the top, the bottom, and the two lateral ends, of the cylindrical outer surface of the extruded body 19. However, the same effect as that of the first embodiment can be achieved by the second embodiment of the present invention shown in FIG. 6, wherein the rollers 55 of the twisting device 54 have a ring-like shape, and a part of the cylindrical inner surface of each roller 55 is brought into contact with the cylindrical outer surface of the extruded body 19 so that the rollers 55 respectively and sequentially touch the top, the bottom, and the two lateral ends of the extruded body 19 in such a direction as to twist the extruded body 19. At that time, by sequentially bringing a part of the cylindrical inner surface of each roller 55 into contact with the cylindrical outer surface of the extruded body 19 in such a direction as to twist the extruded body 19, it is possible to twist the extruded body 19 evenly and more efficiently.

Another method of twisting the extruded body 19 is offered by the third embodiment of the present invention shown in FIG. 7, wherein the twisting device 54 includes a ring-shaped roller 55. This third embodiment calls for inserting the extruded body 19 into the roller 55 in the state that the cylindrical outer surface of the extruded body 19 is in contact with the inner surface of the roller 55, while rotating the roller 55 by rotating a drive roller 61 which is in contact with the cylindrical outer surface of the roller 55. As it is capable of evenly twisting the extruded body 19, the third embodiment described above can achieve the same effect as that of the first embodiment. When using the configuration of the third embodiment, the inner surface of the roller 55 is required to have a relatively great coefficient of friction in order to prevent the outer surface of the extrusion from slipping on the inner surface of the roller 55. Furthermore, the inner diameter of the roller 55 has to be nearly the same as the outer diameter of the extruded body 19.

The fourth embodiment of the present invention shown in FIG. 8 offers yet another configuration which calls for bringing the cylindrical outer surface of rollers 55 into contact with the cylindrical outer surface of the extruded body 19 in such a state that the rollers 55 are arranged at an angle to the extruded body 19 and rotating the rollers 55 in respective directions so that a part of the rotation force of each roller 55 is applied in the direction of extrusion of the extruded body 19. As rotation of the rollers 55 applies an axial tension to the extruded body 19, the extruded body 19 can be twisted circumferentially while being pulled. In other words, the extruded body 19 pushed out of the molding device 51 can be both pulled and twisted by the twisting device 54 alone. By thus eliminating the necessity of a device for pulling the extruded body 19, the fourth embodiment described above further improves the manufacturability of the extruded body 19. Furthermore, the force for pulling the extruded body 19 can be adjusted by controlling the angle and/or rotation speed of each roller 55 of the twisting device 54 or pressure applied when bringing the rollers 55 into contact with the extruded body 19.

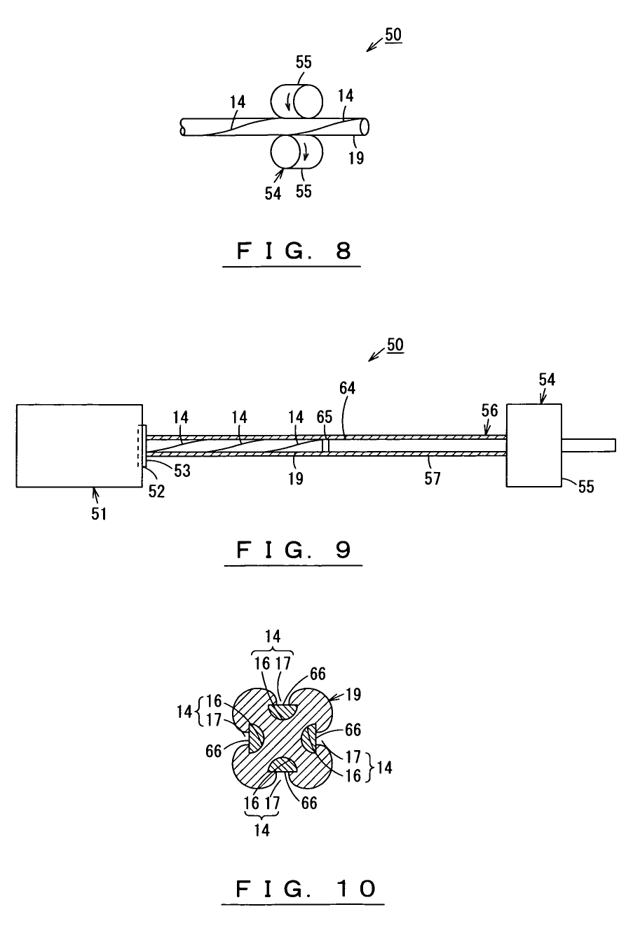

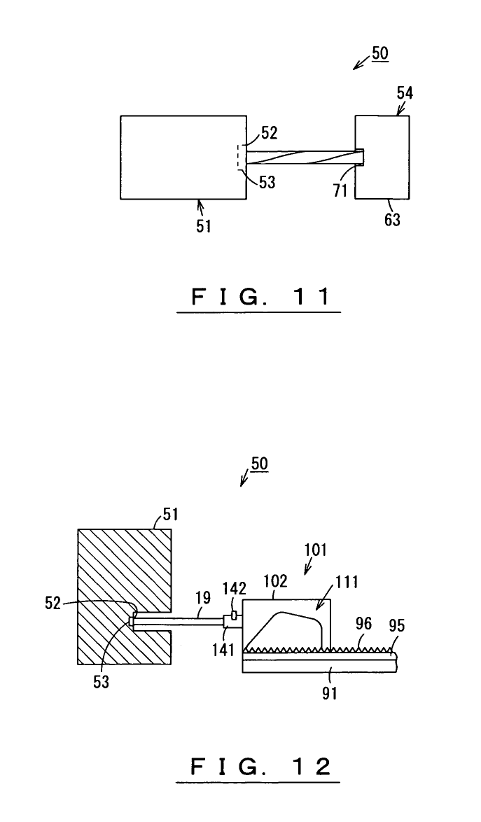

Next, the structure of the fifth embodiment of the present invention is explained hereunder, referring to FIGS. 9 and 10.

The shaft manufacturing apparatus 50 shown in FIGS. 9 and 10 is basically the same as the shaft manufacturing apparatus 50 shown in FIGS. 1 through 5, except that the shaft manufacturing apparatus 50 of this embodiment functions to chuck the leading end of an extruded body 19 extruded from the extrusion nozzle 53 of the molding device 51 and simultaneously pull and twist the extruded body 19.

The shaft manufacturing apparatus 50 is designed to form the extruded body 19 by extruding an aluminum material from the extrusion nozzle 53 of the molding device 51 in the direction perpendicular to the open surface of the extrusion nozzle 53. Thus formed extruded body 19 is provided along its cylindrical outer surface with a plurality of catching grooves 14, each of which is in the shape of a straight line extending in the axial direction, because protrusions extending parallel to the axis of the extrusion nozzle 53 are formed in the inner surface of the extrusion nozzle 53 in such a shape and such locations that the aforementioned axially extending linear catching grooves 14 are formed along the cylindrical outer surface of the extruded body 19. These protrusions of the extrusion nozzle 53 are not shown in the drawings.

A twisting device 54 for circumferentially twisting an extruded body 19 extruded from the extrusion nozzle 53 is disposed so as to face the extrusion nozzle 53. The twisting device 54 includes a main body portion 63, which is in the shape of a rectangular block. A rotary shaft 64 passes through the central portions of the front and rear panels of the main body portion 63 in such a manner that the rotary shaft 64 is capable of moving back and forth. The rotary shaft 64 is an axial member having its axis extending in the horizontal direction and serves as a stabilizing means.

The axis of the rotary shaft 64 extends in the direction in which the extrusion nozzle 53 of the molding device 51 is open and is adapted to be moved in the axial direction by the pushing force of the extruded body 19, which is formed by extrusion from the extrusion nozzle 53. The rotary shaft 64 is a twisting means that is adapted to be circumferentially rotated by the main body portion 63. The speed and direction of rotation of the rotary shaft 64 may be changed by the main body portion 63, provided that the rotary shaft 64 rotates faster than the speed at which the extruded body 19 is twisted by the extrusion nozzle 53 of the molding device 51.

A pinching portion 65 is formed at an end of the rotary shaft 64, i.e. the end facing the extrusion nozzle 53 of the molding device 51. The pinching portion 65 serves to securely pinch the leading end of the extruded body 19 extruded from the extrusion nozzle 53. The pinching portion 65 is comprised of a plurality of fitting claws 66, which has a claw-like shape and are adapted to be respectively fitted, from the leading end of the extruded body 19, to the flaring portions 16 of the catching grooves 14 of the extruded body 19 so as to securely pinch the leading end the extruded body 19, thereby chucking the extruded body 19. In the case of the present embodiment, four fitting claws 66 are provided.

The fitting claws 66 protrude from the nozzle-facing end of the rotary shaft 64 in parallel with the axis of the rotary shaft 64. Each fitting claw 66 has a hemi-circular cross section nearly identical to the shape of the cross section of the flaring portion 16 of each catching groove 14. With the configuration as above, the twisting device 54 circumferentially twists the extruded body 19 by rotating the rotary shaft 64 circumferentially in the state that the extruded body 19 extruded from the extrusion nozzle 53 of the molding device 51 is immovably pinched by the fitting claws 66 of the rotary shaft 64, which are snugly fitted from the leading end of the extruded body 19 into the respective catching grooves 14 of the extruded body 19.

A guide device 56 is provided in such a manner that its tubular portion 57 concentrically faces the extrusion nozzle 53 of the molding device 51. The distal end of the tubular portion 57 is in contact with the outer rim of the extrusion nozzle 53 of the molding device 51. The extruded body 19 pushed out of the extrusion nozzle 53 is inserted into the tubular portion 57 of the guide device 56 and advances in tubular portion 57 in the state that its lower part is supported by the tubular portion 57.

The base end of the tubular portion 57 is connected to the main body portion 63 of the twisting device 54. The rotary shaft 64 is inserted through the main body portion 63 in such a manner as to be capable of advancing into and retreating from the base end side of the tubular portion 57. The inner diameter of the tubular portion 57 is slightly greater than the outer diameter of the rotary shaft 64 of the twisting device 54.

With the configuration as above, the shaft manufacturing apparatus 50 shown in FIGS. 9 and 10 is capable of forming an extruded body 19 having a plurality of spiral-shaped catching grooves 14 formed along the cylindrical outer surface of the extruded body 19. The shaft manufacturing apparatus 50 forms such an extruded body 19 by securely supporting the extruded body 19 that has undergone twisting while being extruded from the extrusion nozzle 53 of the molding device 51 by fitting each fitting claw 66, which is provided at the end of the rotary shaft 64 of the twisting device 54, in the portion near the leading end of each respective catching groove 14 of the extruded body 19, and simultaneously twisting and pulling the portion of the extruded body 19 between the extrusion nozzle 53 and the rotary shaft 64 by means of rotation of the rotary shaft 64. Therefore, the shaft manufacturing apparatus 50 shown in FIGS. 9 and 10 is capable of achieving the same effect as that of the shaft manufacturing apparatus 50 shown in FIGS. 1 through 5.

The structure described above calls for chucking the end of an extruded body 19 by using the fitting claws 66 of the rotary shaft 64, and simultaneously pulling and twisting the extruded body 19 by the twisting device 54. In other words, according to the embodiment, the extruded body 19 can be simultaneously pulled and twisted by a single twisting device 54. Therefore, compared with a structure that calls for individual devices for twisting and pulling the extruded body 19, the embodiment offers a simplified mechanism of twisting and pulling the extruded body 19 and consequently improves the manufacturability of a shaft 15 to be produced from the extruded body 19.

The fifth embodiment described above calls for immovably pinching an end of the extruded body 19 extruded from the extrusion nozzle 53 of the molding device 51 and, in this state, simultaneously pulling and twisting the extruded body 19 by the twisting device 54. As it is capable of twisting the extruded body 19 without causing minute imperfections to the extruded body 19, such a process is superior to a process that calls for bringing rollers 55 into contact with the outer surface of the extruded body 19 and twisting the extruded body 19 by means of rotation of the rollers 55.

As an end of the tubular portion 57 of the guide device 56 is in contact with the extrusion nozzle 53 of the molding device 51, the lower part of the extruded body 53 is supported by the inner surface of the tubular portion 57 simultaneously with extrusion of the extruded body 19 from the extrusion nozzle 53. By thus preventing slackening of the extruded body 19 more reliably, which slackening might otherwise occur when the extruded body 19 has been extruded from the extrusion nozzle 53, the fifth embodiment described above improves the roundness of the shaft 15 to be produced from the extruded body 19.

According to the fifth embodiment described above, the rotary shaft 64 projects from the main body portion 63 of the twisting device 54 towards the extrusion nozzle 53 of the molding device 51, and the extruded body 19 extruded from the extrusion nozzle 53 of the molding device 51 is rotated at a constant rotation speed while being pulled in the state that an end of the extruded body 19 is secured by the distal end of the rotary shaft 64. However, the rotary shaft 64 of the twisting device 54 may be designed to be rotated at a variable speed in accordance with the length of the extruded body 19 so that the extruded body 19 is twisted at a constant twisting angle per unit length of the extruded body 19.

An example of an alternate configuration that is capable of achieving the same effect as that of the fifth embodiment described above is offered in the sixth embodiment of the present invention shown in FIG. 11, wherein an end of an extruded body 19 extruded from the extrusion nozzle 53 of the molding device 51 while being twisted is fitted in a holding recess 71 that is formed in a side of the main body portion 63 of the twisting device 54, and the extruded body 19 is further twisted by rotating the holding recess 71 of the main body portion 63 while the main body portion 63 is moved in sync with extrusion of the extruded body 19 to apply tensile force to the extruded body 19.

Although the sixth embodiment described above calls for the twisting device 54 to further twist the extruded body 19 in the normal direction, i.e. the same direction in which the extruded body 19 ha been twisted by the extrusion nozzle 53 of the molding device 51, the twisting device 54 may be designed to twist the extruded body 19 in reverse, i.e. in the opposite direction of twisting the extruded body 19 by the extrusion nozzle 53 of the molding device 51, so that the twist of the extruded body 19 by the extrusion nozzle 53 of the molding device 51 can be corrected afterwards.

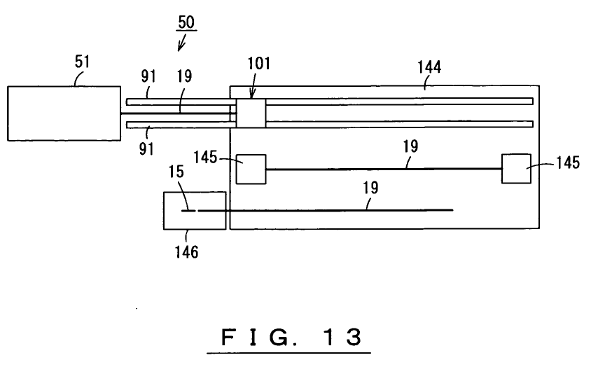

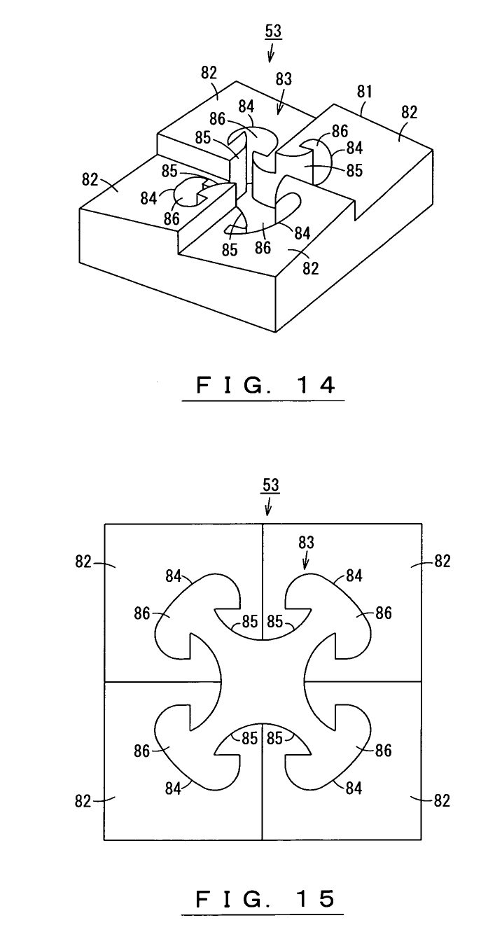

Next, the structure of the seventh embodiment of the present invention is explained hereunder, referring to FIGS. 12 through 19.

As shown in FIGS. 14 and 15, the extrusion nozzle 53 of the shaft manufacturing apparatus 50 has a substantially block-shaped extrusion nozzle body 81. The extrusion nozzle body 81 has a plurality of twisting portions, for example four twisting portions 82) located at one end of the extrusion nozzle body 81 with respect to its thickness, i.e. the upper end as viewed in FIG. 14. As shown in FIG. 15, each twisting portion 82 has a square shape in a plane view so that these twisting portions 82 divide the top of the extrusion nozzle body 81 into nearly identical quartered sections.

Each twisting portion 82 is slanted downward from its upper right corner towards the diagonally opposite corner. The aforementioned upper right corner of each twisting portion 82 means the corner that is located upper-right when the center of the top planar surface of the extrusion nozzle body 81 is located left of the twisting portion 82; in other words, the corner which is adjacent to the twisting portion 82 that is located counterclockwise thereto and located on one of the four edges of the extrusion nozzle body 81. As a result, a step is formed on the top of the extrusion nozzle body 81, at the junction of each twisting portion 82 and the twisting portion 82 that is located adjacent and clockwise thereto. With the configuration as above, the top of each side of the extrusion nozzle body 81 is formed in a saw-tooth shape.

A molding hole 83 is formed the center of the extrusion nozzle body 81 as viewed from the top. The inner surface of the molding hole 83 is adapted to slide on the cylindrical outer surface of the aluminum material filling the interior of the molding device 51. Each twisting portion 82 includes a molding-hole end portion 84 of the molding hole 83. Of each molding-hole end portion 84, the end located at the counterclockwise side rises higher than does the end at the clockwise side, because of the shape of each twisting portion 82. Therefore, each molding-hole end portion 84 is designed such that the vertical dimension of its inner surface is reduced in the clockwise direction. Because of this configuration, the slide resistance of the inner surface of each molding-hole end portion 84, in other words the area of the surface in contact with the cylindrical outer surface of the aluminum material extruded through the extrusion nozzle 53, varies along the circumferential direction of the aluminum material. To be more specific, the slide resistance between the inner surface of each molding-hole end portion 84 and the cylindrical outer surface of the aluminum material extruded through the extrusion nozzle 53 decreases in the clockwise direction.

Each molding-hole end portion 84 is comprised of a projecting portion 85 and a flaring portion 86. Each projecting portion 85 extends from the center of the extrusion nozzle body 81 towards each respective corner of the top surface of the extrusion nozzle body 81. The flaring portion 86 is integrally formed at the distal end of each projecting portion 85 and flares in the widthwise direction of the projecting portion 85. Therefore, when viewed from the top, each molding-hole end portion 84 has a T-like shape. The projecting portions 85 of the molding-hole end portions 84 are connected to one another so as to form arcs. As a whole, the molding hole 83 is so formed in the extrusion nozzle body 81 as to have a point-symmetrical shape when viewed from the top.

With the configuration as above, the aluminum material filling the molding device 51 is horizontally pushed through the extrusion nozzle 53 while sliding along the inner surface of the molding hole 83. At the same time, the aluminum material is evenly twisted in a circumferential direction because of the molding-hole end portions 84 of the molding hole 83. Thus, a shaft 15 having catching grooves 14 formed in a spiral along its cylindrical outer surface as shown in FIG. 3 is formed by extrusion. Each catching groove 14 of the shaft 15 is comprised of a flaring portion 16, which corresponds to a projecting portion 85 of the molding hole 83, and a communicating portion 17, which links the flaring portion 16 with the outer surface of the shaft 15 and corresponds to the flaring portion 86 that is associated with the projecting portion 85.

As shown in FIGS. 12 and 13, a pair of rails 91 that serve as a slide portion and extend in the direction of the thickness of the extrusion nozzle 53, in other words the direction in which the shaft 15 is extruded, are disposed at a given distance from the extrusion nozzle 53 in the direction of the thickness of the extrusion nozzle 53. The rails 91 are spaced apart and extend straight and parallel to each other for a length of, for example, several tens of meters.

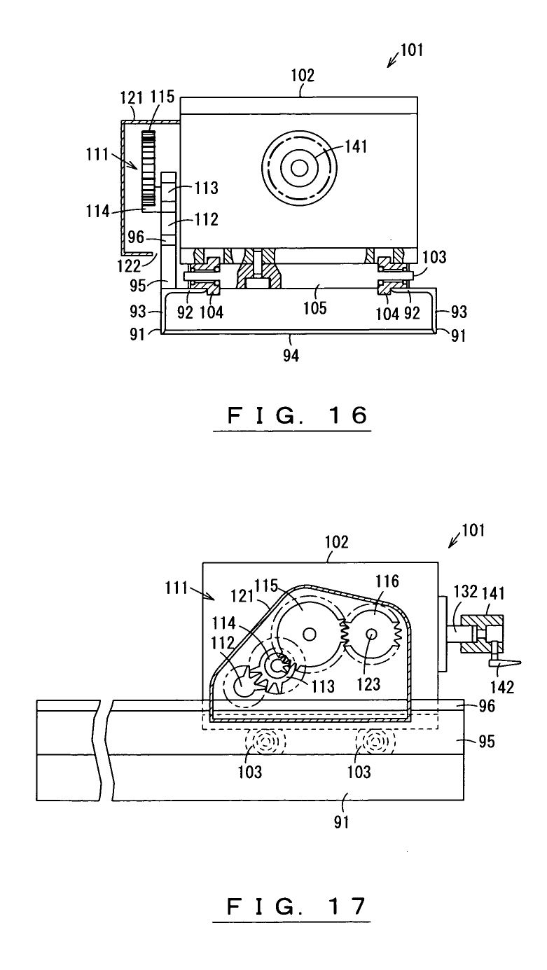

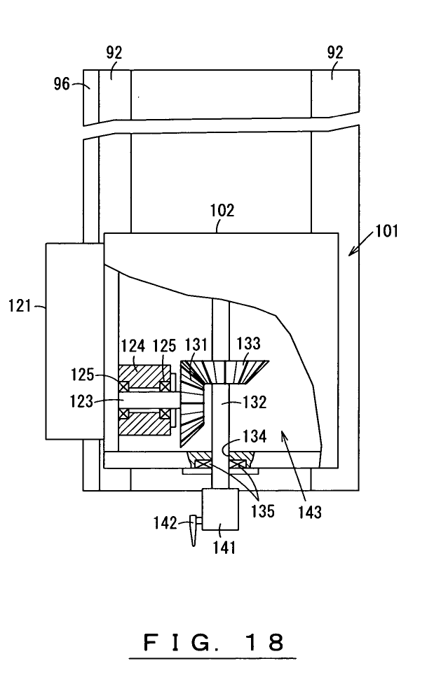

As shown in FIG. 16, each rail 91 is formed of a flat, horizontal plane portion 92 and a vertical portion 93 extending vertically downward from one of the side edges of the plane portion 92 so that the rail 91 has an L-like shape when viewed from the front. In order to reinforce the rails 91 in the widthwise direction, a plurality of reinforcing plates 94 are disposed between the vertical portions 93 of the rails. These reinforcing plates 94 are laid across the two vertical portions 93 and arranged at given intervals along the length of the rails 91.

A guide portion 95 is provided on top of the rail 91 that is located at the front as viewed in FIG. 12 and at the left-hand side as viewed in FIG. 16. The guide portion 95 extends along the rail 91 and projects upward. A zigzag-shaped gear portion 96 is provided at the upper part of the guide portion 95 so that the guide portion 95 has a rack-like shape.

A carriage 101 is installed on the plane portions 92 of the rails 91. The carriage 101 serves as a twisting means for further twisting an end, i.e. the leading end, of the extruded body 19, which is the portion that has been extruded from the extrusion nozzle 53 while being twisted. The carriage 101 has a carriage body 102 in the shape of a hollow, rectangular box. As shown in FIGS. 16 and 17, the underside of the carriage body 102 faces the plane portions 92 of the rails 91, and a pair of wheel arrangements 103 are rotatably attached to this underside of the carriage body 102. The wheel arrangements 103 are space apart in the lengthwise direction of the carriage body 102.

Each wheel arrangement 103 is comprised of wheels 104, 104 and a shaft portion 105 to which the wheels 104, 104 are integrally connected. The wheels 104, 104 are respectively placed on the plane portions 92 of the rails 91. The shaft portion 105 is in the shape of a solid cylinder and extends in the widthwise direction of the carriage body 102. The wheels 104, 104 of each wheel arrangement 103 are respectively in contact with the two opposing ends of the rails 91, which are the ends that face the shaft portion 105 and are opposite the end provided with the vertical portion 93.

The two wheel arrangements 103 are capable of rotating in the lengthwise direction of the rails 91 so as to move the carriage 101 in the lengthwise direction of the rails 91. Therefore, the lengthwise direction of the carriage body 102 corresponds to the traveling directions of the carriage 101.

A gear set 111 that serves as a gear to be engaged with the gear portion 96 of the guide portion 95 is provided at the outer surface of the side panel of the carriage body 102 facing the guide portion 95. The gear set 111 includes a rotatable lower gear 112, a middle gear 113, an interlocking gear 114, a rotatable upper gear 115, and a rotatable drive gear 116 adapted to be engaged with the upper gear 115. The lower gear 112 is a spur gear to be engaged with the gear portion 96. The middle gear 113 is adapted to be engaged with the lower gear 112. The interlocking gear 114 is coaxial with the middle gear 113 so as to rotate interlockingly with rotation of the middle gear 113. The upper gear 115 is adapted to be engaged with the interlocking gear 114.

The gears 112, 113, 114, 115, 116 are arranged in the direction in which the wheel arrangements 103 are arranged. The gears 112, 113, 114, 115, 116 are rotatably supported by shafts to the outer surface of the side panel of the carriage body 102 which faces the guide portion 95. The lower gear 112 may have, for example, 25 gear teeth. The middle gear 113, which may have, for example, 27 gear teeth, is provided at a location slightly above and behind the lower gear 112 with respect to the traveling direction of the carriage 101. The interlocking gear 114 is formed smaller in dimension than the middle gear 113 and disposed at the side of the middle gear 113 facing away from the carriage body 102. The interlocking gear 114 may have, for example, 25 gear teeth. The upper gear 115 is provided at a location slightly above and behind the middle gear 113 with respect to the traveling direction of the carriage 101. The upper gear 115 is the largest of all the gears 112, 113, 114, 115, 116, and may have, for example, 34 gear teeth. The drive gear 116 is provided at nearly the same height as and behind the upper gear 115 with respect to the traveling direction of the carriage 101. The drive gear 116 may have, for example, 25 gear teeth.

Each one of the gears 112, 113, 114, 115, 116 is removably attached to the carriage body 102. The gear set 111 thus comprised of the gears 112, 113, 114, 115, 116 is covered by a safety cover 121, which serves as a cover portion provided at the corresponding side of the carriage body 102. An opening 122 for receiving the gear portion 96 of the guide portion 95 is formed at the bottom of the safety cover 121 so that the safety cover 121 has a U-like shape when viewed in a cross section.

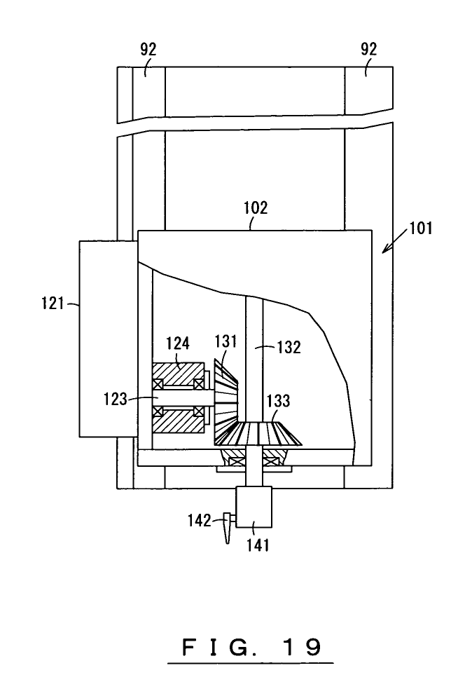

As shown in FIG. 18, the drive gear 116 has a rotary shaft 123 which is inserted through a tubular shaft supporting portion and projects into the carriage body 102. The shaft supporting portion is provided at the inner surface of the side panel of the carriage body 102 which faces the guide portion 95. A plurality of bearings 125 are disposed in the shaft supporting portion 124 so that the cylindrical outer surface of the rotary shaft 123 is slidably supported by these bearings 125.

A gear 131, which is a bevel gear, is coaxially attached to the distal end of the rotary shaft 123. The gear 131 is adapted to rotate together with the drive gear 116. The gear 131 may have, for example, 20 gear teeth. A horizontally extending power output shaft 132 is rotatably disposed in the carriage body 102. The power output shaft 132 is a rotary shaft in the shape of a solid cylinder and extending in the traveling direction of the carriage body 102. The power output shaft 132 is located at the middle of the width of the carriage body 102 and extends along the entire length of the carriage body 102.

A mesh gear 133, which is a bevel gear adapted to be engaged with the gear 131 is coaxially placed around the power output shaft 132 and removably attached to the axial center of the power output shaft 132. The mesh gear 133 is adapted to engage with the front portion of the outer surface of the gear 131 with respect to the traveling direction of the carriage 101 and is capable of rotating in the direction that is nearly perpendicular to the gear 131. The number of teeth of the mesh gear 133 is set at twice the number of teeth of the gear 131. In other words, in the case of the present embodiment, the mesh gear 133 has 40 gear teeth.

A through hole 134 is formed in the panel of the carriage body 102 located at the rear end with respect to the traveling direction of the carriage body 102. The distal end of the power output shaft 132 is passed through this through hole 134 and projects rearward from the carriage body 102. A plurality of bearings 135 are attached to the inner surface of the through hole 134 so that the cylindrical outer surface of the power output shaft 132 is slidably supported by these bearings 135.

As shown in FIGS. 17 and 18, a substantially cylindrical coupler 141 is coaxially attached to the distal end of the power output shaft 132, which ends projects rearward with respect to the traveling direction of the carriage body 102. The coupler 141 serves as a receiving portion for chucking, i.e. supporting, the leading end of the extruded body 19 extruded from the molding device 51. Therefore, the coupler 141 can be rotated together with the power output shaft 132. The coupler 141 is open in the direction in which the carriage 101 travels. A lock handle 142 is attached to a side of the coupler 141. The lock handle 142 serves as a clamping portion for supporting the extruded body 19 inside the coupler 141 by clamping the cylindrical outer surface of the extruded body 19.

The rotary shaft 123, the gear 131, the power output shaft 132, the mesh gear 133, the coupler 141, and the lock handle 142 together form a supporting unit 143 as shown in FIG. 18.

As the gear set 111 and the combination of the gear 131 and the mesh gear 133 enable the supporting unit 143 to rotate in sync with the movement of the carriage 101, there is a given relationship, for example proportional relationship, between the distance traveled by the carriage 101 in the lengthwise direction of the rails 91 and the angle of circumferential rotation of the coupler 141 of the supporting unit 143, in other words the angle the shaft 15 is circumferentially twisted.

By designing the gears 112, 113, 114, 115, 116 of the gear set 111, the gear 131, and the mesh gear 133 to have desired numbers of teeth respectively, the relationship between the distance traveled by the carriage 101 in the lengthwise direction of the rails 91 and the angle the shaft 15 is circumferentially twisted can be changed.

As shown in FIG. 13, a platform 144 having a rectangular shape when viewed from the top is provided under the rails 91. The platform 144 serves as a seating portion on which the extruded body 19 will be placed. The platform 144 is disposed so as to extend in the lengthwise direction of the rails 91, from a location at a given distance from the molding device 51 to the ends of the rails 91 that are opposite the molding device 51.

A pair of hydraulic cylinders 145 that serve as a hydraulic slack-correction device for straightening the slack of the extruded body 19 caused by the weight of the extruded body 19 are disposed on the platform 144. The hydraulic cylinders 145 are disposed to the side of the rails 91, near the two lengthwise ends of the platform 144 respectively, and aligned parallel to the rails 91.

A cutter 146 for producing shafts 15 by cutting the extruded body 19 to a given length is disposed at the end of the platform 144 facing the molding device 51. The cutter 146 may be a high-speed cutter or any other appropriate cutting machine.

Next, a method of producing a rotary brush according to the seventh embodiment described above is explained.

After filling the interior of the molding device 51 of the shaft manufacturing apparatus 50 with an aluminum material, the shaft manufacturing apparatus 50 is started up.

As a result of the activation of the shaft manufacturing apparatus 50, the aluminum material is heated and, when it is ready to be formed, pushed out of the molding hole 83 of the extrusion nozzle 53 of the shaft manufacturing apparatus 50.

At that time, because of the difference in circumferential slide resistance of the extrusion nozzle 53, a circumferential twisting force is applied to the aluminum material which is being pushed through the molding hole 83 of the extrusion nozzle 53. As a result, the aluminum material is extruded while being twisted in the circumferential, clockwise direction. Thus, an extruded body 19 is formed, with a plurality of catching grooves 14 formed in a spiral along the cylindrical outer surface of the extruded body 19.

The catching grooves 14 formed along the cylindrical outer surface of the extruded body 19 are in the shape of a spiral having a longer turning pitch than that of the catching grooves 14 of the shaft 15 into which the extruded body 19 is to be formed.

The leading end portion of the extruded body 19, which is the portion of the material extruded from the extrusion nozzle 53 of the shaft manufacturing apparatus 50, is inserted into the coupler 141 of the carriage 101. The lock handle 142 is then tightened to clamp the end of the extruded body 19 by the coupler 141.

Thereafter, the carriage 101 is moved along the rails 91 by being pushed manually or any other appropriate means at a given speed, for example at nearly the same speed as the speed at which the extruded body 19 is extruded by the molding device 51.

At that time, the lower gear 112 becomes engaged with the gear portion 96 of the guide portion 95 and rotates counterclockwise as viewed in FIG. 17 so that the middle gear 113 becomes engaged with the lower gear 112 and rotates clockwise as viewed in FIG. 17.

Together with the middle gear 113, the interlocking gear 114 rotates clockwise as viewed in FIG. 17. By engaging with the interlocking gear 114, the upper gear 115 rotates counterclockwise as viewed in FIG. 17, and, by engaging with the upper gear 115, the drive gear 116 rotates clockwise as viewed in FIG. 17.

Together with the drive gear 116, the gear 131 rotates clockwise as viewed in FIG. 17. By engaging with the gear 131, the mesh gear 133 rotates clockwise as viewed in FIG. 18 so that the extruded body 19 is circumferentially twisted clockwise.

In other words, the extruded body 19 is twisted circumferentially by a given angle in accordance with the distance traveled by the carriage 101 along the rails 91.

After being twisted by the carriage 101, the turning pitch of the spirals of the catching grooves 14 that are formed along the cylindrical outer surface of the extruded body 19 is the same as that of the catching grooves 14 of the shaft 15 into which the extruded body 19 is to be formed.

The angle for circumferentially twisting the extruded body 19 according to the distance traveled by the carriage 101 can be changed by changing the number of the teeth of any desired gear or gears from among the gears 112, 113, 114, 115, 116 of the gear set 111, the gear 131, and the mesh gear 133.

The extruded body 19 can be twisted counterclockwise as viewed in FIG. 16 by forming the extrusion nozzle 53 in the shape of a mirror image of the shape shown in FIG. 14 and attaching the mesh gear 133 to the power output shaft 132 as shown in FIG. 19 so as to engage the mesh gear 133 with the rear portion of the gear 131 with respect to the traveling direction of the carriage 101.

After being twisted by the carriage 101, the extruded body 19 is placed on the platform 144, and its two axial ends are respectively attached to and pulled in the axial directions by the two hydraulic cylinders 145. As a result, the slacking of the extruded body 19 caused by its own weight is straightened.

By cutting the extruded body 19 to a given length by means of the cutter 146 after the extruded body 19 has hardened by unaided cooling, formation of the shaft 15 is completed.

As described above, the process of producing a shaft 15 according to the seventh embodiment of the invention is comprised of steps of forming an extruded body 19 by simultaneously extruding and circumferentially twisting an aluminum material by means of the molding device 51 so that four catching grooves 14 are formed in a spiral along the cylindrical outer surface of the extruded body 19, moving the carriage 101 along the rails 91 in the state the coupler 141 of the carriage 101 clamps the end of the extruded body 19 extruded from the molding device 51 so that the gear set 111 and the supporting unit 143 twist the extruded body 19 at an angle proportional to the distance traveled by the carriage 101 along the rails 91, the extruded body 19 being twisted in the direction in which the extruded body 19 has been twisted by the molding device 51, and, thereafter, cutting the extruded body 19 to a given length by the cutter 146.

With the configuration as above, which calls for twisting the base end and the distal end of the extruded body 19 by the molding device 51 and the carriage 101 respectively, the seventh embodiment enables the extruded body 19 to be twisted at plurality of locations. As the extruded body 19 can be twisted at a precise angle according to the distance traveled by the carriage 101, the embodiment ensures that the extruded body 19 is circumferentially twisted by a constant degree per unit length of distance traveled by the carriage 101.

Therefore, compared with a conventional method that calls for twisting an aluminum material solely by the molding device 51, the embodiment described above ensures that a shaft 15 is formed with a satisfactory twisting precision and, consequently, has a desired shape even if the distance by which the aluminum material is extruded is increased and results in an increased weight of the material.

By replacing the gears 112, 113, 114, 115, 116 of the gear set 111, the gear 131, and the mesh gear 133 with those having different numbers of teeth or by any other means to change the numbers of the teeth or the gear ratio of the gears 112, 113, 114, 115, 116, the gear 131, and the mesh gear 133, the proportional relationship between the distance traveled by the carriage 101 and the twisting angle of the extruded body 19 can be changed as desired.

By running the carriage 10 along the length of the rails 91 at nearly the same speed as the speed at which the extruded body 19 is extruded by the molding device 51, the embodiment described above prevents the extruded body 19 from being burdened with an excessive axial load or from slacking due to its own weight.

As the molding device 51 is provided with the extrusion nozzle 53, the twisting direction in which the shaft 15 is circumferentially twisted by the molding device 51 can be easily changed by changing the extrusion nozzle 53.

The twisting direction of the extruded body 19 can be easily changed merely by forming the extrusion nozzle 53 into the shape of a mirror image of the shape shown in FIGS. 14 and 15 and attaching the mesh gear 133 to the power output shaft 132 so as to engage the mesh gear 133 with the rear portion of the gear 131 with respect to the traveling direction of the carriage 101.

This feature of the seventh embodiment makes the shaft manufacturing apparatus 50 applicable to various types of shafts 15 which are different in twisting angles or twisting directions, and, consequently, makes the shaft manufacturing apparatus 50 more convenient to use.

A step is formed on the top of the extrusion nozzle body 81, at the junction of each twisting portion 82 and the twisting portion 82 that is located adjacent and clockwise thereto. Therefore, when the aluminum material is extruded through the molding hole 83, the slide resistance with the inner surface of the molding hole 83 is different between the clockwise end and the counterclockwise end of each molding-hole end portion 84 of the molding hole 83. This feature makes it easy for the molding device 51 to circumferentially twist the extruded body 19 merely by the shape of the extrusion nozzle 53.

By using a pair of hydraulic cylinders to support and axially pull both ends of the extruded body 19, the embodiment prevents slacking of the extruded body 19 due to its own weight. By thus eliminating the possibility of the extruded body 19 that has been extruded from becoming distorted before it becomes hard, the embodiment described above improves the roundness of the shaft 15 to be produced from the extruded body 19.

The carriage 101 of the seventh embodiment described above may be designed to move along the length of the rails in a manner of autonomous travel by driving the wheel arrangements 103 by a motor (not shown) or the like.

Detailed design of the carriage 101 is not limited to the structure described above, provided that it permits the extruded body 19 circumferentially at such a given angle as to have a given relationship with the distance traveled by the carriage 101 in the lengthwise direction of the rails 91.

Furthermore, according to the seventh embodiment described above, shafts 15 are produced by an extrusion process using the shaft manufacturing apparatus 50 so as to form an extruded body 19 having a length equivalent to a total length of a plurality of shafts 15 connected to one another, and cutting the extruded body 19 to a given length. However, the shaft manufacturing apparatus 50 may be used to form an extruded body 19 that has the same length as that of the shaft 15 to be produced as a final product. If such is the case, the elimination of the necessity of the hydraulic cylinders 145 and the cutter 146 results in the reduction of installation space required.

Although the extruded body 19 that has been twisted by the carriage 101 is allowed to cool and harden according to the first embodiment, the extruded body 19 may be forced to cool down by air-cooling, such as air blowing by a fan, water-cooling, such as spraying water, or any other appropriate method.

Although the extruded body 19 extruded from the extrusion nozzle 53 of the molding device 51 is twisted in a spiral along the entire axial length of the extruded body 19 according to the embodiments described above, the extruded body 19 may be twisted into such a shape that each spiral is bent at a point into a V-like shape by securing the middle portion of the extruded body 19 or any other appropriate means.

The invention is applicable to not only canister type vacuum cleaners but also those of other types, such as, for example, an upright type cleaner provided with a floor brush 9 which is formed directly under the cleaner main body 1, or a vacuum cleaner having integrated cleaner main body 1 and floor brush 9, such as those of a self-propelled type or hand-held type.

The floor brush 9 may be provided with a plurality of rotary brushes 13. Furthermore, instead of rotating the rotary brush 13 by the motor 41 as in the cases of the embodiments described above, it is also permissible to rotate the rotary brush 13 by using the air sucked in by the motor fan 2.

Although the shaft 15 is provided with four catching grooves 14 according to the embodiments described above, the number of catching grooves 14 are deemed sufficient should there be at least one catching groove 14, provided that the shaft 15 requires catching grooves 14 in a number corresponding to the number of cleaning members to be attached to the shaft 15. The cleaning members are not limited to brush members 21 or scraping members 22; for example, floor scrubbing members provided with cloth blades or the like may also be used. Although the brush members 21 and the scraping members 22 are alternately attached to the catching grooves 14 of the shaft 15 according to the embodiments described above, the arrangement of the cleaning members is not limited to the arrangement comprised of alternating members; it is also permissible to attach a single kind or various kinds of scraping members 22.

### INDUSTRIAL APPLICABILITY

As described above, the method and device for producing a mounting member according to the invention have a wide range of use as a method and an apparatus for producing a shaft which is used in, for example, a rotary cleaning member of a vacuum cleaner or the like.

1. A method of producing a cylindrical mounting member of a rotary cleaning device, wherein the mounting member comprises a cylindrical outer surface and a plurality of receiving grooves formed in a spiral along the cylindrical outer surface, and wherein the mounting member is adapted to permit base ends of cleaning members to be snugly caught in the receiving grooves respectively so that the cleaning members are attached to the cylindrical outer surface of the mounting member in such a manner as to be wound around the mounting member in the spiral, said method comprising:
forming said mounting member by extrusion while twisting it so as to form the plurality of receiving grooves along the cylindrical outer surface of the mounting member; and
pulling the mounting member which is being extruded.

2. The method as claimed in claim 1, further comprising:
circumferentially twisting the extruded portion of the mounting member while pulling said extruded portion.

3. A method of producing a cylindrical mounting member of a rotary cleaning device, wherein the mounting member comprises a cylindrical outer surface and a plurality of receiving grooves formed in a spiral along the cylindrical outer surface, and wherein the mounting member is adapted to permit base ends of cleaning members to be snugly caught in the receiving grooves respectively so that the cleaning members are attached to the cylindrical outer surface of the mounting member in such a manner as to be wound around the mounting member in the spiral, said method comprising:
forming said mounting member by extrusion so that a plurality of straight receiving grooves are formed along the cylindrical outer surface of the mounting member; and
simultaneously twisting in a circumferential direction and pulling the mounting member which is being extruded so as to cause said receiving grooves around the mounting member to be wound in the spiral.

4. An apparatus for producing a cylindrical mounting member of a rotary cleaning device, wherein the mounting member comprises a cylindrical outer surface and a plurality of receiving portions are formed in the cylindrical outer surface so as to extend in a spiral in the lengthwise direction of the mounting member, and wherein the mounting member is adapted to permit base ends of cleaning members to be attached to the receiving portions respectively so that the cleaning members are attached to the cylindrical outer surface of the mounting member in such a manner as to be wound around the mounting member in the spiral, said apparatus comprising:
forming means for forming said mounting member by extrusion while twisting it so as to form the plurality of receiving portions along the cylindrical outer surface; and
twisting means for supporting an end of the mounting member extruded from said forming means and twisting the supported mounting member in a direction in which said forming means twists the mounting member, while moving in a direction in which the mounting member is extruded from said forming means;
wherein there is a given relationship between an angle of circumferential twisting of the mounting member and a distance traveled by the mounting member in the direction in which the mounting member is extruded from said forming means.

5. The apparatus as claimed in claim 4, wherein the forming means comprises a tubular extrusion nozzle having an inner surface on which the mounting member slides during extrusion, and a slide resistance between the inner surface of the extrusion nozzle and the mounting member that is being extruded is different depending on a circumferential location, such that a circumferential twisting force is applied to the mounting member which is being extruded.

6. The apparatus as claimed in claim 4, wherein the relationship between the angle of circumferential twisting of the mounting member and the distance traveled by the mounting member is changeable.

7. The apparatus as claimed in claim 4, further comprising a rack-shaped guide portion which extends in the direction in which the mounting member is extruded from said forming means; and
wherein the twisting means comprises: (i) a gear portion adapted to mesh with said guide portion, and (ii) a supporting unit which supports the end of the mounting member extruded from the forming means and which driven by the gear portion to circumferentially twist the mounting member.
